(19) United States
(12) Patent Application Publication
(10) Pub. No.: US 2026/0209516 A1
(43) Pub. Date: Jul. 23, 2026

(54) POLY(ARYLENE SULFIDE) RESIN COMPOSITION, MOLDED ARTICLE, AND PRODUCTION METHODS THEREFOR

(71) Applicant: DIC Corporation, Tokyo (JP)

(72) Inventors: Yoshihisa Takahashi, Ichihara-shi (JP); Ryuhei Kurokawa, Ichihara-shi (JP); Kunito Kurata, Ichihara-shi (JP)

(73) Assignee: DIC Corporation, Tokyo (JP)

(21) Appl. No.: 19/140,013

(22) PCT Filed: Dec. 7, 2023
(86) PCT No.: PCT/JP2023/043750

§ 371 Date: Jun. 17, 2025

(30) Foreign Application Priority Data
Jan. 12, 2023 (JP) 2023-002998

(51) Int. Cl. C08L 81/02; B29C 45/00; B29C 45/46; B29K 27/18; B29K 81/00; B29K 277/00; B29L 15/00

(52) U.S. Cl. CPC C08L 81/02; B29C 45/0001; B29C 45/46; B29K 2023/06; B29K 2027/18; B29K 2081/04; B29K 2277/10; B29K 2995/0073; B29K 2995/0087; B29L 2015/003; C08L 2205/035; C08L 2205/16

(57) ABSTRACT

Provided are a poly(arylene sulfide) (PAS) molded article having excellent balance of mechanical strength and sliding properties, and high durability; a PAS resin composition capable of providing the molded article; and production methods therefor. More specifically, provided are a PAS resin composition obtained by mixing a PAS resin (A), polyamide fibers (B), and a solid lubricant (C), in which the PAS resin (A) has a melt viscosity (V6) of 50 to 2,000 Pa·s, the polyamide fibers (B) are mixed in an amount of 5 to 35 parts by mass and the solid lubricant (C) is mixed in an amount of 5 to 30 parts by mass, relative to 100 parts by mass of the PAS resin (A), and a molded article has a tensile strength of a weld part of 40 MPa or more in ISO 527-1 and 2; a molded article; and production methods therefor.

### TECHNICAL FIELD

The present invention relates to a poly(arylene sulfide) resin composition, a poly(arylene sulfide) resin molded article, and production methods therefor.

### BACKGROUND ART

In recent years, investigation of the formation of a gear, which was previously made of metal, from resin has been actively performed for thinning and weight reduction in robot development. For example, the need for a highly heat-resistant engineering plastic with a high melting point as a metal alternative material for a sliding material for a gear, a bearing, and the like is increasing. However, when a resin material is used in the applications, the mechanical strength and the sliding properties are insufficient under a high-load environment, and there was a problem of low durability.

Meanwhile, poly(arylene sulfide) resins (hereinafter referred to as “PAS resins”) typified by poly(phenylene sulfide) resins (hereinafter referred to as “PPS resins”) are engineering plastics that have excellent heat resistance and chemical resistance, and the like and are widely utilized. As a PAS resin with excellent sliding properties, for example, a sliding material obtained by combining PPS, 5 to 50% by weight of a lubricant, and 5 to 30% by weight of polyaramid fibers having an average fiber length of 1 to 25 mm has been disclosed (PTL 1). In addition, PTL 2 has disclosed a resin composition including 100 parts by weight of a PAS resin synthesized through a polymerization reaction using an aromatic disulfide-based compound as a polymerization terminator, 10 to 180 parts by weight of carbon fibers, wholly aromatic polyamide fibers or glass fibers.

### CITATION LIST

### Patent Literature

PTL 1: Japanese Unexamined Patent Application Publication No. S63-162727
PTL 2: International Publication WO2015/119123

### SUMMARY OF INVENTION

### Technical Problem

However, the mechanical strength and sliding properties of a PAS resin composition obtained by a conventional method are insufficient to use the PAS resin composition as a member in a high-load environment, and further improvement has been required.

An object of the present invention is to provide a PAS molded article having excellent balance of mechanical strength and sliding properties, and high durability, a PAS resin composition capable of providing the molded article, and production methods therefor.

### Solution to Problem

The inventors of the present invention have intensively studied to solve the aforementioned problems, as a result have found that when polyamide fibers and a solid lubricant are mixed in predetermined amounts relative to the amount of a PAS resin, excellent balance of mechanical strength and sliding properties, and high durability are achieved, and have completed the present invention.

That is, the present disclosure relates to a PAS resin composition obtained by mixing a PAS resin (A), polyamide (hereinafter sometimes referred to as PA) fibers (B), and a solid lubricant (C), in which the PAS resin (A) has a melt viscosity (V6) of 50 to 2,000 Pa·s, measured after being held at 300° C., a load of 1.96×10⁶ Pa, and L/D of 10 (mm)/1 (mm) for 6 minutes,
the PA fibers (B) are mixed in an amount of 5 to 35 parts by mass and the solid lubricant (C) is mixed in an amount of 5 to 30 parts by mass, relative to 100 parts by mass of the PAS resin (A), and
a molded article in which a molten resin is filled symmetrically from both ends of a dumbbell shape conforming to a specimen of type A defined in ISO 20753 has a tensile strength of a weld part of 40 MPa or more in ISO 527-1 and 2.

In addition, the present disclosure relates to a PAS resin molded article obtained by molding the PAS resin composition described above.

Moreover, the present disclosure relates to a sliding member including the molded article described above.

In addition, the present disclosure relates to a production method for a PAS resin composition including a step of mixing a PAS resin (A), PA fibers (B), and a solid lubricant (C), and melt-kneading the mixture at a temperature equal to or higher than the melting point of the PAS resin (A), in which
the PAS resin (A) has a melt viscosity (V6) of 50 to 2,000 Pa·s, measured after being held at 300° C., a load of 1.96×10⁶ Pa, and L/D of 10 (mm)/1 (mm) for 6 minutes,
the PA fibers (B) are mixed in an amount of 5 to 35 parts by mass and the solid lubricant (C) is mixed in an amount of 5 to 30 parts by mass, relative to 100 parts by mass of the PAS resin (A), and
a molded article in which a molten resin is filled symmetrically from both ends of a dumbbell shape conforming to a specimen of type A defined in ISO 20753 has a tensile strength of a weld part of 40 MPa or more in ISO 527-1 and 2.

In addition, the present disclosure relates to a production method for a molded article, the method including steps of: producing a PAS resin composition by the production method described above; and melt-molding the obtained PAS resin composition.

### Advantageous Effects of Invention

According to the present invention, a PAS molded article having excellent balance of mechanical strength and sliding properties, and high durability, a PAS resin composition capable of providing the molded article, and production methods therefor can be provided.

### DESCRIPTION OF EMBODIMENTS

Hereinafter, an embodiment of the present invention will be described in detail, but the scope of the present invention is not limited to the embodiment herein, and various modifications may be made without departing from the spirit of the present invention. When a plurality of upper limit values and a plurality of lower limit values of a specific parameter are described, a suitable numerical value range can be obtained by combining any upper limit value and any lower limit value among the upper limit values and the lower limit values.

A PAS resin composition according to the present embodiment is a PAS resin composition obtained by mixing a PAS resin (A), PA fibers (B), and a solid lubricant (C), and is characterized in that the PAS resin (A) has a melt viscosity (V6) of 50 to 2,000 Pa·s, measured after being held at 300° C., a load of 1.96×10⁶ Pa, and L/D of 10 (mm)/1 (mm) for 6 minutes, and the PA fibers (B) are mixed in an amount of 5 to 35 parts by mass and the solid lubricant (C) is mixed in an amount of 5 to 30 parts by mass, relative to 100 parts by mass of the PAS resin (A). This will be described below.

### <PAS Resin (A)>

The PAS resin composition according to the embodiment contains a PAS resin as an essential component.

The PAS resin has a resin structure containing as a repeating unit a structure in which an aromatic ring is bonded to a sulfur atom. Specifically, the PAS resin composition is a resin containing a structural moiety represented by the following general formula (1):

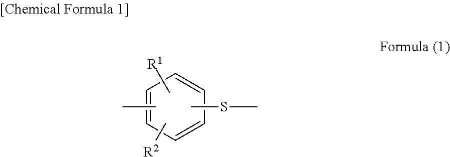

(wherein R¹ and R² are each independently a hydrogen atom, an alkyl group having 1 to 4 carbon atoms, a nitro group, an amino group, a phenyl group, a methoxy group, or an ethoxy group), and if necessary, a trifunctional structural moiety represented by the following general formula (2):

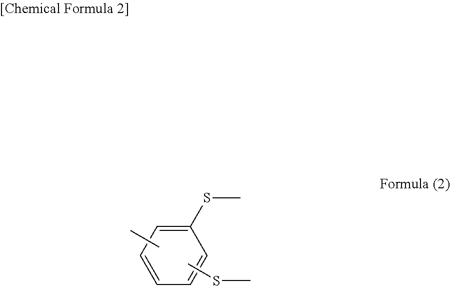

as repeating units. The amount of the trifunctional structural moiety represented by the formula (2) is preferably within the range of 0.001 to 3% by mole, and particularly preferably within the range of 0.01 to 1% by mole, relative to the total number of moles of other structural moieties.

Herein, the structural moiety represented by the formula (1), especially R¹ and R² in the formula are preferably a hydrogen atom in terms of mechanical strength of the PAS resin. In this case, examples of the structural moiety include a structural moiety represented by the following formula (3) and having bonds at para positions and a structural moiety represented by the following formula (4) and having bonds at meta positions.

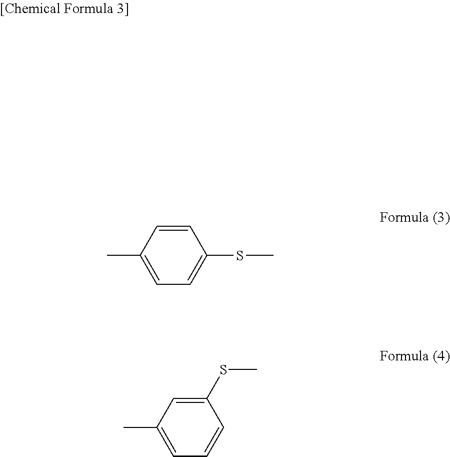

In particular, the structural moiety represented by the general formula (3) in which a bond of the aromatic ring to the sulfur atom in the repeating unit is a bond at a para position is preferred in terms of heat resistance and crystallinity of the PAS resin.

The PAS resin may contain not only the structural moieties represented by the formulae (1) and (2), but also structural moieties represented by the following structural formulae (5) to (8)

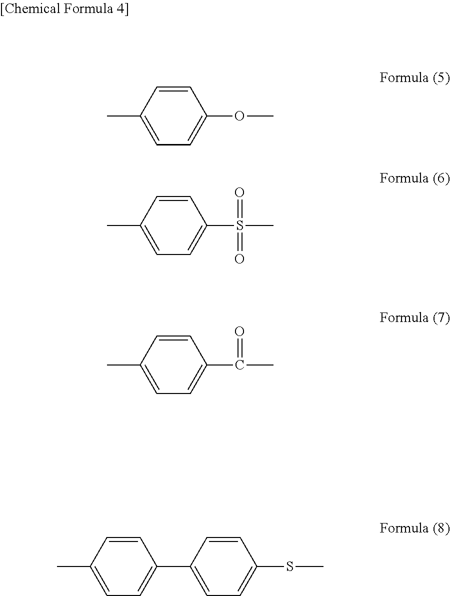

in an amount of 30% by mole or less relative to the total amount of the structural moieties represented by the formulae (1) and (2). In particular, in the present disclosure, it is preferable that the amount of the structural moieties represented by the general formulae (5) to (8) be 10% by mole or less in terms of heat resistance and mechanical strength of the PAS resin. When the PAS resin contains the structural moieties represented by the general formulae (5) to (8), the structural moieties may be bonded at any pattern to form any of a random copolymer or a block copolymer.

The molecular structure of the PAS resin may have a naphthyl sulfide bond and the like, and the amount thereof is preferably 3% by mole or less, and particularly preferably 1% by mole or less, relative to the total amount of the molecular structure and another structural moiety.

The physical properties of the PAS resin are not particularly limited as long as the effects of the present invention are not impaired, and are as described below.

### (Melt Viscosity)

The melt viscosity of the PAS resin used in the embodiment is not particularly limited. The melt viscosity (V6) measured at 300° C. is preferably 2 Pa·s or more, and preferably 1,000 Pa·s or less, more preferably 500 Pa·s or less, and further preferably 300 Pa·s or less since processability and mechanical strength are well balanced. In the measurement of the melt viscosity (V6), a flow tester CFT-500D manufactured by Shimadzu Corporation is used for the PAS resin. The melt viscosity is a value measured after the PAS resin is held at 300° C., a load of 1.96×10⁶ Pa, and a L/D of 10 (mm)/1 (mm) for 6 minutes.

### (Non-Newtonian Index)

The non-Newtonian index of the PAS resin used in the embodiment is not particularly limited, and is preferably within the range of 0.90 or more and 2.00 or less. When a linear PAS resin is used, the non-Newtonian index is preferably 0.90 or more, and more preferably 0.95 or more, and preferably 1.50 or less, and more preferably 1.20 or less. Such a PAS resin has excellent mechanical physical properties, flowability, and wear resistance. In the present disclosure, the non-Newtonian index (N value) is a value calculated by the following equation from a shear rate (SR) and a shear stress (SS) that are measured using Capilograph under conditions of the melting point plus 20° C. and a ratio L/D of an orifice length (L) to an orifice diameter (D) of 40. As the non-Newtonian index (N value) is closer to 1, the structure is closer to a linear shape. As the non-Newtonian index (N value) is higher, the structure is more branched.

$$S R = K \cdot S {S}^{N} \qquad [ Equation 1 ]$$

(wherein SR represents a shear rate (s⁻¹), SS represents a shear stress (dyn/cm²), and K is a constant.)

### (Carboxy Group Content)

The carboxy group content of the PAS resin used in the embodiment is preferably within the range of 10 μmol/g or more and 200 μmol/g or less, and more preferably within the range of 20 μmol/g or more and 180 μmol/g or less. When the carboxy group content is within such a range, a molded article having excellent durability can be obtained while the resin composition has favorable processability. In the present disclosure, the carboxy group content is a value measured by the method described in Examples.

### (Production Method)

A production method for the PAS resin is not particularly limited, and examples thereof include: (method 1) a method in which a dihaloaromatic compound, and if necessary, a polyhaloaromatic compound or another copolymerization component are polymerized in the presence of sulfur and sodium carbonate; (method 2) a method in which a dihaloaromatic compound, and if necessary, a polyhaloaromatic compound or another copolymerization component are polymerized in a polar solvent in the presence of sulfide-forming agent and the like; (method 3) a method for self-condensing p-chlorothiophenol, with another copolymerization component if necessary; and (method 4) a method in which a diiodo aromatic compound and a simple substance sulfur are melt-polymerized under reduced pressure in the presence of a polymerization inhibitor that may have a functional group such as a carboxy group and an amino group. Among these methods, the method 2 is preferred since it is widely used. During a reaction, an alkali metal salt of carboxylic acid or sulfonic acid, or an alkali hydroxide may be added to adjust the degree of polymerization. The PAS resin obtained by the method 2, especially a method in which a water-containing sulfide-forming agent is introduced into a mixture containing a heated organic polar solvent and a dihaloaromatic compound at a speed at which water can be removed from a reaction mixture, and if necessary, a polyhaloaromatic compound is added, the dihaloaromatic compound and the sulfide-forming agent are reacted in the organic polar solvent, and the amount of water in the reaction system is controlled within the range of 0.02 to 0.5 mol relative to 1 mol of the organic polar solvent to produce the PAS resin (see Japanese Unexamined Patent Application Publication No. H07-228699) or a method in which a dihaloaromatic compound, and if necessary, a polyhaloaromatic compound or another copolymerization component are reacted with an alkali metal hydrosulfide and an alkali metal salt of an organic acid in the presence of a solid alkali metal sulfide and an aprotic polar organic solvent while the amount of the alkali metal salt of an organic acid is controlled within the range of 0.01 to 0.9 mol relative to 1 mol of sulfur source and the amount of water in the reaction system is controlled to be 0.02 mol or less relative to 1 mol of the aprotic polar organic solvent (see WO2010/058713) is particularly preferred. Specific examples of the dihaloaromatic compound include p-dihalobenzene, m-dihalobenzene, o-dihalobenzene, 2,5-dihalotoluene, 1,4-dihalonaphthalene, 1-methoxy-2,5-dihalobenzene, 4,4′-dihalobiphenyl, 3,5-dihalobenzoic acid, 2,4-dihalobenzoic acid, 2,5-dihalonitrobenzene, 2,4-dihalonitrobenzene, 2,4-dihaloanisole, p,p′-dihalodiphenyl ether, 4,4′-dihalobenzophenone, 4,4′-dihalodiphenyl sulfone, 4,4′-dihalodiphenyl sulfoxide, 4,4′-dihalodiphenyl sulfide, and compounds having an alkyl group having 1 to 18 carbon atoms on the aromatic ring of any of the aforementioned compounds. Examples of the polyhaloaromatic compound include 1,2,3-trihalobenzene, 1,2,4-trihalobenzene, 1,3,5-trihalobenzene, 1,2,3,5-tetrahalobenzene, 1,2,4,5-tetrahalobenzene, and 1,4,6-trihalonaphthalene. A halogen atom contained in the aforementioned compounds is desirably a chlorine atom or a bromine atom.

A post-treatment method for a reaction mixture containing the PAS resin obtained by a polymerization step is not particularly limited. Examples thereof include (post-treatment 1) a method in which after completion of a polymerization reaction, a solvent is distilled off under reduced pressure or normal pressure from the reaction mixture as it is or after addition of an acid or a base, a solid material after distillation of the solvent is washed with a solvent such as water, the reaction solvent (or an organic solvent having the same solubility in a low molecular weight polymer), acetone, methyl ethyl ketone, and an alcohol, one or two or more times, followed by neutralization, water-washing, filtration, and drying; (post-treatment 2) a method in which after completion of a polymerization reaction, a solvent (a solvent that is soluble in the solvent used for polymerization and is a poor solvent to at least PAS) such as water, acetone, methyl ethyl ketone, an alcohol, an ether, a halogenated hydrocarbon, an aromatic hydrocarbon, and an aliphatic hydrocarbon is added as a precipitating agent, to precipitate PAS and a solid product such as an inorganic salt, and they are filtered off, washed, and dried; (post-treatment 3) a method in which after completion of a polymerization reaction, a reaction solvent (or an organic solvent having the same solubility in a low molecular weight polymer) is added to the reaction mixture and then stirred, the low molecular weight polymer is removed by filtration, and the resultant is washed with a solvent such as water, acetone, methyl ethyl ketone, and an alcohol, one or two or more times, followed by neutralization, water-washing, filtration, and drying; (post-treatment 4) a method in which after completion of a polymerization reaction, water is added to wash the reaction mixture, and if necessary, an acid is added to treat the reaction mixture during water-washing, followed by filtration and drying; and (post-treatment 5) a method in which after completion of a polymerization reaction, the reaction mixture is filtered, and if necessary, washed with the reaction solvent one or two or more times, and then washed with water, followed by filtration and drying. Among the methods, the method of the post-treatment 4 is preferred since a PAS resin having a carboxy group on the terminal of the molecule thereof is obtained.

In the post-treatment method described in the post-treatments 1 to 5, the PAS resin may be dried in vacuum, in air, or in an inert gas atmosphere such as nitrogen.

### <Polyamide Fibers (B)>

The PAS resin composition according to the embodiment contains PA fibers (B) as an essential component.

The PA fibers (B) adaptable in the embodiment are not particularly limited, and publicly known fibers can be used as long as the fibers are formed from a PA resin. In particular, wholly aromatic PA fibers (aramid fibers) produced using one or more types of aromatic diamines and one or more types of aromatic dicarboxylic acid halides are preferred from the viewpoint of heat resistance and mechanical strength. Examples of the aramid fibers include meta-type aramid fibers and para-type aramid fibers. Among the aramid fibers, para-type aramid fibers are preferred, and copolymerized para-type aramid fibers typified by copoly(p-phenylene-3,4′-oxydiphenylene terephthalamide) are particularly preferred.

The shape of the PA fibers (B) is not particularly limited as the fibers are fibrous. The fiber diameter and the fiber length, as well as the aspect ratio, and the like may be appropriately adjusted according to the application of a molded body, and the like. From the viewpoint of exhibiting more excellent mechanical strength, the average fiber length is preferably 0.1 mm or more, and more preferably 0.5 mm or more, and preferably 6 mm or less, and more preferably 4 mm or less.

The mixing amount of the PA fibers (B) in the PAS resin composition according to the embodiment is preferably 5 parts by mass or more, and more preferably 7 parts by mass or more, and preferably 35 parts by mass or less, and more preferably 25 parts by mass or less, relative to 100 parts by mass of the PAS resin (A). When the amount is within such a range, the resin composition has favorable processability and the wear resistance and mechanical strength, and dimensional stability of a molded article are excellent. Therefore, this is preferred.

In addition, the PA fibers (B) that are processed with a surface treatment agent or a sizing agent can also be used. This is preferred since the adhesion force to the PAS resin can be enhanced. Examples of the surface treatment agent or the sizing agent include at least one type of polymer selected from the group consisting of a silane compound, a titanate compound, an acrylic resin, a urethane resin, an ester resin, and an epoxy resin having a functional group, such as an amino group, an epoxy group, an isocyanate group, or a vinyl group.

### <Solid Lubricant (C)>

The PAS resin composition according to the embodiment contains a solid lubricant (C) as an essential component. In the present invention, the solid lubricant is a solid at normal temperature (23° C.) and a substance with a dynamic friction coefficient of 0.2 or less.

The solid lubricant applicable to the embodiment is not particularly limited, and a publicly known solid lubricant can be used. Examples thereof include polytetrafluoroethylene (PTFE), polyethylene, graphite, boron nitride, molybdenum disulfide, and carbon fibers. In particular, PTFE and polyethylene are preferred from the viewpoint of sliding properties and processability.

The mixing amount of the solid lubricant (C) in the PAS resin composition according to the embodiment is preferably 5 parts by mass or more, and more preferably 8 parts by mass or more, and preferably 30 parts by mass or less, and more preferably 25 parts by mass or less, relative to 100 parts by mass of the PAS resin (A). When the amount is within such a range, the resin composition has favorable processability and the wear resistance and mechanical strength of a molded article are excellent. Therefore, this is preferred.

### <Liquid Silicone Resin (D)>

The PAS resin composition according to the embodiment can further contain a liquid silicone resin (D) as an optional component to improve the wear resistance and reduce the friction coefficient.

As the liquid silicone resin adaptable in the embodiment, a publicly known silicone resin that is a silicone resin in a liquid state at normal temperature (23° C.) can be used without particular restriction. Examples of the liquid silicone resin include dimethyl silicone and methylphenyl silicone. In addition, a liquid silicone resin, part of a side chain, a terminal, or both terminals of which is modified can be used. Examples of a modified functional group include an amino group, an epoxy group, a carboxy group, a carbinol group, a methacrylic group, a fluorine group, an alkyl group, an alkylaralkyl group, a polyether group, a mercapto group, a phenol group, and an ester group. In the embodiment, unmodified dimethyl silicone, unmodified methylphenyl silicone, amino-modified dimethyl silicone, carboxy-modified dimethyl silicone, amino-modified methylphenyl silicone, or carboxy-modified methylphenyl silicone is preferably used.

In addition, the kinematic viscosity of the liquid silicone resin adaptable in the resin composition according to the embodiment is preferably 100 mm²/s or more, and more preferably 500 mm²/s or more, and preferably 30,000 mm²/s or less, and more preferably 20,000 mm²/s or less. When the kinematic viscosity is within such a range, the resin composition has favorable processability and the wear resistance and mechanical strength of a molded article are excellent. Therefore, this is preferred. The kinematic viscosity in the present disclosure is a value measured in accordance with JIS K2283-2000.

The PAS resin composition according to the embodiment can contain a filler as an optional component within a range not impairing the effects of the present invention. Examples of the filler include fillers having various shapes, such as a fibrous filler, a plate-like filler, and a granular filler. Specifically, examples thereof include glass fibers, carbon fibers, glass flakes, milled fibers, clay, pyrophyllite, bentonite, sericite, mica, talc, attapulgite, ferrite, calcium silicate, zeolite, boehmite, silica, quartz powder, glass beads, glass powder, calcium silicate, aluminum silicate, and diatomaceous earth, metal oxides such as iron oxide, titanium oxide, zinc oxide, and alumina, metal carbonates such as calcium carbonate and magnesium carbonate, metal sulfates such as calcium sulfate and barium sulfate, fumed silica, other silicon carbide, silicon nitride, boron nitride, various types of metal powders, and plant-derived fillers such as cacao husk. In the present disclosure, one or two or more types of the fillers can be used in combination. In particular, hydrotalcite, calcium carbonate, talc, zinc carbonate, alumina, magnesium hydroxide, boron nitride, or magnesium carbonate can be preferably used. The size and aspect ratio of the filler may be appropriately adjusted according to the application of a molded article, and the like.

When the filler, which is not an essential component in the embodiment, is mixed, the mixing amount of the filler is not particularly limited as long as the effects of the present invention are not impaired. For example, the mixing amount of another filler is preferably 1 part by mass or more, and more preferably 5 parts by mass or more, and preferably 600 parts by mass or less, and more preferably 200 parts by mass or less, relative to 100 parts by mass of the PAS resin (A). When the amount is within such a range, the resin composition exhibits favorable moldability, and a molded article has excellent mechanical properties. Therefore, this is preferred.

The PAS resin composition according to the embodiment can contain as an optional component a silane-coupling agent, if necessary. The silane-coupling agent is not particularly limited as long as the effects of the present invention are not impaired. Preferable examples of the silane-coupling agent include a silane-coupling agent having a functional group to be reacted with a carboxy group, such as an epoxy group, an isocyanato group, an amino group, or a hydroxyl group. Examples of such a silane-coupling agent include epoxy group-containing alkoxysilane compounds, such as γ-glycidoxypropyltrimethoxysilane, γ-glycidoxypropyltriethoxysilane, and B-(3,4-epoxycyclohexyl)ethyltrimethoxysilane, isocyanato group-containing alkoxysilane compounds, such as γ-isocyanatepropyltrimethoxysilane, γ-isocyanatepropyltriethoxysilane, γ-isocyanatepropylmethyldimethoxysilane, γ-isocyanatepropylmethyldiethoxysilane, γ-isocyanatepropylethyldimethoxysilane, γ-isocyanatepropylethyldiethoxysilane, and γ-isocyanatepropyltrichlorosilane, amino group-containing alkoxysilane compounds, such as γ-(2-aminoethyl)aminopropylmethyldimethoxysilane, γ-(2-aminoethyl)aminopropyltrimethoxysilane, and γ-aminopropyltrimethoxysilane, and hydroxyl group-containing alkoxysilane compounds, such as γ-hydroxypropyltrimethoxysilane, and γ-hydroxypropyltriethoxysilane. When the silane-coupling agent, which is not an essential component in the present invention, is mixed, the mixing amount of the silane-coupling agent is not particularly limited as long as the effects of the present invention are not impaired. The amount is preferably 0.01 parts by mass or more, and more preferably 0.1 parts by mass or more, and preferably 10 parts by mass or less, and more preferably 5 parts by mass or less, relative to 100 parts by mass of the PAS resin (A). When the amount is within such a range, the resin composition has favorable corona resistance and moldability, especially releasability, and the mechanical strength of a molded article is enhanced. Therefore, this is preferred.

The PAS resin composition according to the embodiment can contain as an optional component a thermoplastic elastomer, if necessary. Examples of the thermoplastic elastomer include a polyolefin-based elastomer, a fluorine-containing elastomer, and a silicone-based elastomer. Among these, a polyolefin-based elastomer is preferred. When the elastomer is added, the amount of the elastomer is not particularly limited as long as the effects of the present invention are not impaired. The mixing amount of the elastomer is preferably 0.01 parts by mass or more, and more preferably 0.1 parts by mass or more, and preferably 10 parts by mass or less, and more preferably 5 parts by mass or less, relative to 100 parts by mass of the PAS resin (A). When the amount is within such a range, the impact resistance of the obtained PAS resin composition is improved. Therefore, this is preferred.

Examples of the polyolefin-based elastomer include a homopolymer of α-olefin, a copolymer of two or more α-olefins, and a copolymer of one or two or more α-olefins with a vinyl polymerizable compound having a functional group. Examples of the α-olefins include α-olefins having 2 or more and 8 or less carbon atoms, such as ethylene, propylene, and 1-butene. Examples of the functional group include a carboxy group, an acid anhydride group (—C(═O)OC(═O)—), an epoxy group, an amino group, a hydroxyl group, a mercapto group, an isocyanate group, and an oxazoline group. Examples of the vinyl polymerizable compound having the functional group include one or two or more of vinyl acetate; α,β-unsaturated carboxylic acids, such as (meth)acrylic acid; alkyl esters of α,β-unsaturated carboxylic acids, such as methyl acrylate, ethyl acrylate, and butyl acrylate; metal salts of α,β-unsaturated carboxylic acids, such as an ionomer (in which the metal is an alkali metal such as sodium, an alkaline earth metal such as calcium, zinc, or the like); glycidyl esters of α,β-unsaturated carboxylic acids, such as glycidyl methacrylate; α,β-unsaturated dicarboxylic acids, such as maleic acid, fumaric acid, and itaconic acid; and derivatives (monoester, diester, acid anhydride) of the α,β-unsaturated dicarboxylic acids. The thermoplastic elastomer may be used alone, or two or more types thereof may be used in combination.

In addition to the aforementioned components, according to applications, the PAS resin composition according to the embodiment can further contain as an optional component a synthetic resin (hereinafter simply referred to as synthetic resin), such as a polyester resin, a PA resin, a polyimide resin, a polyetherimide resin, a polycarbonate resin, a polyphenylene ether resin, a polysulfone resin, a polyether sulfone resin, a polyetherether ketone resin, a polyether ketone resin, a polyarylate resin, a polyethylene resin, a polypropylene resin, a polytetrafluoroethylene resin, a polydifluoroethylene resin, a polystyrene resin, an ABS resin, an epoxy resin, a phenol resin, a urethane resin, or a liquid crystal polymer, as appropriate. In particular, it is preferable that a fluorine-containing resin be mixed since sliding properties are further improved. In the present invention, when the synthetic resin, which is not an essential component, is mixed, the amount of the synthetic resin mixed is not particularly limited as long as the effects of the present invention are not impaired. The amount varies according to the purpose thereof, and cannot be generally defined. For example, the amount of the synthetic resin mixed in the resin composition according to the embodiment is within the range of 5 parts by mass or more and 15 parts by mass or less relative to 100 parts by mass of the PAS resin (A). In other words, the ratio by mass of the amount of the PAS resin to the total amount of the PAS resin (A) and the synthetic resin is preferably 100/115 or more, and more preferably 100/105 or more.

Furthermore, the PAS resin composition according to the embodiment may contain as an optional component a commonly known additive, such as a colorant, an antistat, an antioxidant, a heat-resistant stabilizer, an ultraviolet stabilizer, an ultraviolet absorber, a foaming agent, a flame retarder, a flame retardant promoter, an antirust agent, or a release agent (a metal salt or ester of fatty acid having 18 to 30 carbon atoms, including stearic acid or montanic acid, a polyolefin wax such as polyethylene, etc.), if necessary. The additive is not an essential component. The amount of the additive is preferably 0.01 parts by mass or more, and preferably 1,000 parts by mass or less, more preferably 100 parts by mass or less, and further preferably 10 parts by mass or less, relative to 100 parts by mass of the PAS resin (A). The amount of the additive may be appropriately adjusted according to a purpose and use application for use without impairing the effects of the present invention.

In addition, the PAS resin composition of the present disclosure is characterized by having a weld strength of 40 MPa or more. Moreover, the weld strength is preferably 45 MPa or more, and more preferably 50 MPa or more. When the weld strength is within such a range, a PAS resin molded article has excellent durability. In order to adjust the weld strength within such a range, for example, a method in which the melt viscosity (V6) of the PAS resin is adjusted within the range of 50 to 2,000 Pa·s according to the content proportion of the PAS resin in the resin composition is adopted. For example, when a large amount of inorganic filler is mixed as a component other than the PAS resin, the crystallization rate of the resin composition tends to increase, and hence the melt viscosity of the PAS resin is increased to adjust crystallization behavior. A method for adjusting the weld strength is not limited to the aforementioned method. In addition, the weld strength in the present disclosure is the tensile strength of a weld part in ISO 527-1 and 2 of a molded article in which a molten resin is filled symmetrically from both ends of a dumbbell shape conforming to a specimen of type A defined in ISO 20753, and can be measured by the method described in Examples.

### <Production Method for PAS Resin Composition>

A production method for a PAS resin composition according to the embodiment is a production method for a PAS resin composition including a step of mixing the PAS resin (A), the liquid silicone resin (B), PA fibers (C), and the solid lubricant (C), and melt-kneading the mixture at a temperature equal to or higher than the melting point of the PAS resin (A), in which
the PAS resin (A) has a melt viscosity (V6) of 50 to 2,000 Pa·s, measured after being held at 300° C., a load of 1.96×10⁶ Pa, and L/D of 10 (mm)/1 (mm) for 6 minutes,
the PA fibers (B) are mixed in an amount of 5 to 35 parts by mass and the solid lubricant (C) is mixed in an amount of 5 to 30 parts by mass, relative to 100 parts by mass of the PAS resin (A), and
a molded article in which a molten resin is filled symmetrically from both ends of a dumbbell shape conforming to a specimen of type A defined in ISO 20753 has a tensile strength of a weld part of 40 MPa or more in ISO 527-1 and 2. The method will be described in detail below.

The production method for the PAS resin composition according to the embodiment includes a step of mixing the aforementioned essential components and melt-kneading the mixture at a temperature range equal to or higher than the melting point of the PAS resin (A). More specifically, the PAS resin composition according to the embodiment contains the essential components and if necessary, the other optional component. Examples of the production method for the resin composition used in the present invention include, but not particularly limited to, a method in which the essential components and if necessary, the optional component are mixed and melt-kneaded, and specifically, are homogeneously mixed under drying by a tumbler, a Henschel mixer, or the like, if necessary, and then supplied to a twin-screw extruder and melt-kneaded.

Melt-kneading can be performed under heating within a temperature range at which the resin temperature is equal to or higher than the melting point of the PAS resin (A), a temperature range at which the resin temperature is preferably equal to or higher than the melting point plus 10° C., and a temperature range at which the resin temperature is more preferably equal to or higher than the melting point plus 10° C., or still more preferably equal to or higher than the melting point plus 20° C., and preferably equal to or lower than the melting point plus 100° C., or still more preferably equal to or lower than the melting point plus 50° C.

From the viewpoint of dispersibility and productivity, it is preferable that a melt-kneader be a twin-screw kneading extruder. For example, it is preferable that melt-kneading be performed while the amount of resin component discharged is controlled within the range of 5 to 500 (kg/hr) and the screw rotation speed is controlled within the range of 50 to 500 (rpm) as appropriate, and it is further preferable that melt-kneading be performed under a condition in which the ratio (the amount/the rotation speed) is within the range of 0.02 to 5 (kg/hr/rpm). Each of the components may be added to the melt-kneader and mixed simultaneously or separately. For example, when the PA fibers (B) as the essential component among the components and, if necessary, the other fibrous filler are added, it is preferable that they be supplied to the extruder from a side feeder of the twin-screw kneading extruder from the viewpoint of dispersibility. The side feeder is positioned such that the ratio of the distance between a resin-supplying portion (top feeder) of the extruder and the side feeder to the full length of screw of the twin-screw kneading extruder is preferably 0.1 or more, and more preferably 0.3 or more. The ratio is preferably 0.9 or less, and more preferably 0.7 or less.

The PAS resin composition according to the embodiment thus obtained by melt-kneading is a melt-kneaded mixture containing the essential components, and the optional component and a component derived from the optional component added, if necessary. Therefore, the PAS resin composition according to the embodiment has morphology in which the PAS resin (A) forms a continuous phase and the other essential component and the optional component are dispersed. That is, the PAS resin composition according to the embodiment has a sea-island structure in which an island phase containing at least the solid lubricant (C) is dispersed in a continuous phase containing the PAS resin (A). The average dispersion diameter of the solid lubricant (C) is preferably 50 μm or less, and more preferably 40 μm or less from the viewpoint of suppressing a reduction in mechanical strength. A method for measuring the average dispersion diameter will be described in detail in Examples.

It is preferable that after the melt-kneading, a publicly known method be performed, for example, the PAS resin composition according to the embodiment in a melted state be extrusion molded into a strand shape and then processed in a form of pellet, chip, granule, powder, or the like, and if necessary, pre-dried within the temperature range of 100 to 150° C.

### <PAS Resin Molded Article and Production Method for PAS Resin Molded Article>

A molded article according to the embodiment is formed by melt-molding the PAS resin composition. A production method for the molded article according to the embodiment includes a step of melt-molding the PAS resin composition. Therefore, the molded article according to the embodiment has morphology in which the PAS resin (A) forms a continuous phase and the other essential components and the optional component are dispersed. The PAS resin composition has such morphology, and hence a molded article having excellent thermal conductivity and mechanical strength is obtained.

In addition, the molded article according to the embodiment has small dimensional changes due to water absorption. Specifically, the dimensional change ratio due to water absorption is preferably 0.2% or less, more preferably 0.15% or less, and further preferably 0.1% or less. The water absorption phenomenon of a resin is generally a phenomenon where water penetrates into an amorphous part of the resin and polymer chains swell, and hence the amount of water holding between the polymer chains and dimensional changes are in a proportional relationship. Therefore, in the case where the dimensional change ratio due to water absorption is 0.2% or less, when the molded article of the embodiment is used, for example, as a gear, the molded article is less likely to affect the meshing of gear teeth and a combination with another member, and exhibits more excellent dimensional precision under high humidity or in water. That is, the molded article of the embodiment includes as a constituent component the PAS resin having a low water absorption property, and hence the molded article may have a low dimensional change ratio due to water absorption and excellent dimensional precision under high humidity. The dimensional change ratio due to water absorption is a value measured by the method described in Examples below.

The PAS resin composition according to the embodiment may be subjected to various types of molding, such as injection molding, compression molding, composite, sheet, or pipe extrusion molding, drawing molding, blow molding, and transfer molding. The PAS resin composition is particularly suitable for application of injection molding due to excellent mold releasability. Under molding by injection molding, each molding condition is not particularly limited. The PAS resin composition can be molded usually by a general method. For example, after the step of melting the PAS resin composition in an injection molding machine such that the resin temperature is equal to or higher than the melting point of the PAS resin (A), preferably equal to or higher than the melting point by 10° C., more preferably within the range of the melting point plus 10° C. to the melting point plus 100° C., and further preferably within the range of the melting point plus 20° C. to the melting point plus 50° C., the PAS resin composition may be injected into a mold from a resin discharge port and molded. In this case, the mold temperature may be set within a publicly known temperature range, for example, to room temperature (23° C.) to 300° C., and preferably 130° C. to 190° C.

The production method for the molded article according to the embodiment may include a step of annealing the molded article. In the annealing, an optimal condition is selected depending on the use application, the shape, and the like of the molded article, and the annealing temperature is equal to or higher than the glass transition temperature of the PAS resin (A), preferably equal to or higher than the glass transition temperature plus 10° C., and more preferably equal to or higher than the glass transition temperature plus 30° C. The annealing temperature is preferably 260° C. or lower, and more preferably 240° C. or lower. Although the annealing time is not particularly limited, the annealing time is preferably 0.5 hours or more, and more preferably 1 hour or more. The annealing time is preferably 10 hours or less, and more preferably 8 hours or less. When they are within such ranges, the strain of the obtained molded article is reduced, the crystallinity of the resin is improved, and the thermal conductivity, mechanical properties, and fuel barrier properties are further enhanced. Therefore, this is preferable. The annealing may be performed in air, and preferably in an inert gas such as a nitrogen gas.

The PAS resin molded article according to the embodiment is characterized by having excellent wear resistance and sliding properties such as a low friction coefficient, and hence the PAS resin molded article is suitable for use application of a sliding part. Specifically, the PAS resin molded article may be suitably used for sliding parts, such as a gear, a bearing, a holder, a robot arm, a bearing, and a ball valve. In addition, the molded article according to the embodiment may be a typical resin molded article described below, in addition to the sliding part. Examples thereof include electrical and electronic parts typified by box-shaped protecting and supporting members for electrical and electronic part integrated modules, a plurality of separate semiconductors or modules, a sensor, a LED lamp, a connector, a socket, a resistor, a relay case, a switch, a coil bobbin, a capacitor, a variable capacitor case, a light pickup, an oscillator, various terminal plates, a transformer, a plug, a printed board, a tuner, a speaker, a microphone, a headphone, a compact motor, a magnetic head base, a power module, a terminal stand, a semiconductor, a liquid crystal, a FDD carriage, a FDD chassis, a motor brush holder, a parabola antenna, and a computer-related part; home and office electrical product parts typified by a VTR part, a television part, an iron, a hair dryer, a rice cooker part, a microwave oven part, an acoustic part, audio and video apparatus parts such as an audio laser disk, a compact disk, a DVD disk, and a blue ray disk, an illumination part, a refrigerator part, an air conditioner part, a typewriter part, a word processor part, and water-section apparatus parts such as a water heater and a sensor for water amount and temperature of a bath; machine-related parts typified by an office computer-related part, a telephone-related part, a facsimile-related part, a copying machine-related part, a jig for cleaning, a motor part, a lighter, and a typewriter; optical instruments and precision machine-related parts typified by a microscope, a binocular, a camera, and a clock; and automobile and vehicle-related parts such as an alternator terminal, an alternator connector, a brush holder, a slip ring, an IC regulator, a potentiometer base for light dimmer, a relay block, an inhibitor switch, various valves such as an exhaust gas valve, various fuel-related, outlet, and inlet pipes, an air intake nozzle snorkel, an intake manifold, an engine cooling water joint, a carburetor main body, a carburetor spacer, an exhaust gas sensor, a cooling water sensor, an oil temperature sensor, a brake pad wear sensor, a throttle positioner, a crankshaft positioner, a thermal sensor, an air flow meter, a brake pad wear sensor, an air conditioner thermostat base, a hot-air flow control valve, a brush holder for a radiator motor, a water pump impeller, a turbine vane, a wiper motor-related part, a distributor, a starter switch, an ignition coil and a bobbin thereof, a motor insulator, a motor rotor, a motor core, a starter relay, a wire harness for transmission, a window washer nozzle, an air conditioner panel switch board, a coil for a fuel-related electromagnetic valve, a fuse connector, a horn terminal, an electrical part insulation plate, a stepper motor rotor, a lamp socket, a lamp reflector, a lamp housing, a brake piston, a solenoid bobbin, an engine oil filter, and an ignition device case. The PAS resin molded article can be adopted in various use applications.

### EXAMPLES

Hereinafter, the present invention will be described using Examples and Comparative Examples. However, the present invention is not limited to these Examples. Hereinafter, “%” and “part(s)” are based on mass unless otherwise specified.

### Examples 1 to 12 and Comparative Examples 1 to 9

Materials were mixed in accordance with composition components and mixing amounts listed in Table 1. The materials were supplied to a twin-screw extruder with a vent “TEX30a (product name)” manufactured by The Japan Steel Works, Ltd., and melt-kneaded at a resin component discharge amount of 30 kg/hr, a screw rotation speed of 200 rpm, and a set resin temperature of 320° C., to obtain pellets of a resin composition. Glass fibers and polyamide fibers were supplied from a side feeder (S/T ratio: 0.5), and other materials were homogeneously mixed in a tumbler in advance and then supplied from a top feeder. The obtained pellets of the resin composition were dried in a geer oven at 140° C. for 2 hours, and then injection-molded to produce various specimens. The specimens were subjected to the following tests.

### Evaluation

### (1) Measurement of Dispersion Diameter

The pellets obtained in each of Examples and Comparative Examples were supplied to an injection molding apparatus (SE-75D-HP) manufactured by Sumitomo Heavy Industries, Ltd., in which a cylinder temperature was set to 310° C., and injection-molded using an ISO D2 sheet specimen molding mold in which the mold temperature was adjusted to 140° C., to obtain an ISO D2 sheet. The cross section of the sheet specimen was measured with a SEM device (“JSM-6360A” manufactured by JEOL Ltd.). In the obtained image, about 100 phases including a solid lubricant (dispersion phases) were randomly selected and the number average particle diameter of the particles was calculated. The particle diameter was calculated as an equivalent diameter. The results are shown in Tables 1 to 4.

### (2) Measurement of Tensile Properties of Weld Part

The pellets obtained in each of Examples and Comparative Examples were supplied to an injection molding apparatus (SE-75D-HP) manufactured by Sumitomo Heavy Industries, Ltd., in which a cylinder temperature was set to 310° C., and injection-molded using an ISO Type 1A dumbbell specimen molding mold in which the mold temperature was adjusted to 140° C., to obtain an ISO Type-A dumbbell specimen. In the production, the resin was injected from two gates such that the specimen contained a weld part. For the obtained dumbbell specimen, the tensile strength was measured by a measurement procedure in accordance with ISO 527-1 and 2. The results are shown in Tables 1 to 4.

### (3) Measurement of Charpy Impact Strength

A dumbbell-shaped specimen was produced by injecting the resin from a single gate under the same conditions as in (2) such that the specimen did not contain a weld part, and the central portion of the dumbbell-shaped specimen was cut into a bar shape with a length of 80 mm, a width of 10 mm, and a thickness of 4 mm and then notched to obtain an impact resistance specimen. The impact resistance specimen was subjected to Charpy impact test in accordance with ISO 179-1/1eA, and the impact strength (kJ/mm²) was measured. The results are shown in Tables 1 to 4.

### (4) Wear Test

The pellets obtained in each of Examples and Comparative Examples were supplied to an injection molding apparatus (SE-75D-HP) manufactured by Sumitomo Heavy Industries, Ltd., in which a cylinder temperature was set to 310° C., and a cylindrical specimen with an inner diameter of 20 mm, an outer diameter of 25 mm, and a height of 15.0 mm was obtained using a mold in which the temperature was adjusted to 140° C. For this cylindrical specimen, the friction coefficient and the specific wear rate (10-3 (mm³/(N×km))) were measured with a Suzuki-type wear tester under the following measurement conditions. The results are shown in Tables 1 to 4.

### Measuring Conditions:

a pressure of 150 kPa, a rotation rate of 0.5 m/second, a measurement time of 60 minutes, and a temperature environment of 23° C. Using two pieces of the specimen obtained by molding with the injection molding apparatus, the Suzuki-type wear test as described above was performed under the aforementioned measurement conditions.

### (5) Evaluation of Durability of Molded Article

The pellets obtained in each of Examples and Comparative Examples were supplied to an injection molding apparatus (SE-75D-HP) manufactured by Sumitomo Heavy Industries, Ltd., in which a cylinder temperature was set to 310° C., and a gear with a module of 1 mm, 30 teeth, and a tooth thickness of 5 mm was obtained using a mold in which the temperature was adjusted to 140° C. and defined as gear A. Similarly, a gear with a module of 1 mm, 31 teeth, and a tooth thickness of 5 mm was obtained and defined as gear B. A sliding test was performed in which the obtained gears A and B were meshed with each other and spur gears were rotated under conditions of 25° C., a torque of 1 Nm, and a rotation speed of 1,000 rpm, and the time until the gear was ruptured was evaluated as a durability time. The results are shown in Tables 1 to 4.

### (6) Evaluation of Moldability

The appearance of the gear A of each of Examples and Comparative Examples obtained in (5) was visually observed. The gear in which the surface is glossy and the resin is filled up to the addendum was evaluated as satisfactory, and the gear in which the surface is not glossy and the resin is not filled up to the addendum was evaluated as poor molding. In addition, the addendum part of the gear A was observed with a microscope, and the presence or absence of burr of 0.1 mm or more was confirmed. The results are shown in Tables 1 to 4.

### (7) Measurement of Dimensional Change Ratio of Gear due to Water Absorption

The gear A of each of Examples and Comparative Examples obtained in (5) was dried at 50° C. for 24 hours and cooled at room temperature (23° C.) in a desiccator. The tip diameter of the cooled gear A was measured at any 10 tooth positions, and the number-average value thereof was defined as the tip diameter (h₀) of the dried gear A. After that, the gear A was immersed in distilled water at room temperature (23° C.) for 30 days. The tip diameter of the immersed gear A was measured at any 10 tooth positions, and the number-average value thereof was defined as the tip diameter (h₁) of the immersed gear A. The change ratio (%) of the tip diameter before and after immersion was calculated from the obtained values by an equation: {(h₁-h₀)/h₀}×100 and defined as the dimensional change ratio (%). The results are shown in Tables 1 to 4.

### (8) Determination of Carboxy Group Content of PAS Resin

The PPS resin used in each of Examples and Comparative Examples was pressed at 350° C. and a load of 10 MPa for 60 seconds and then quenched to 25° C. over 60 seconds to produce an amorphous film. The obtained amorphous film was measured with a Fourier-transform infrared spectrometer (hereinafter abbreviated as “FT-IR spectrometer”). The relative intensity of the absorbance at 1,705 cm⁻¹ relative to the absorbance at 630.6 cm⁻¹ of the infrared absorption spectrum was determined, and the carboxy group content in the measurement sample (hereinafter abbreviated as “total carboxy group content”) was separately determined using a calibration curve created by a method described below. The carboxy group content is represented by the number of moles of carboxy groups in 1 g of a resin mixture and expressed in units of μmol/g. The calibration curve was created by the following method. A predetermined amount of 4-chlorophenylacetic acid was first added to a PAS resin that had been produced so as to have a carboxylate on the terminal of the molecule without acid treatment, and sufficiently mixed, the same film as described above was produced, and measurement was performed with a FT-IR spectrometer. The calibration curve was created by plotting the relative intensity ratio of absorbances at the two wavelengths described above with respect to the carboxy group content calculated from the addition amount of 4-chlorophenylacetic acid.

TABLE 1

| | | | Ex. 1 | Ex. 2 | Ex. 3 | Ex. 4 | Ex. 5 | Ex. 6 |
|---|---|---|---|---|---|---|---|---|
| Composition | A-2 | Part by mass | 100 | | | | | |
| | A-3 | Part by mass | | 100 | 100 | 100 | 100 | 100 |
| | B-1 | Part by mass | 20 | 20 | 20 | 20 | 5 | 30 |
| | C-1 | Part by mass | 20 | 20 | 5 | 30 | 20 | 20 |
| | E-1 | Part by mass | 0.5 | 0.5 | 0.5 | 0.5 | 0.5 | 0.5 |
| Evaluation | Dispersion | μm | 12 | 12 | 12 | 12 | 12 | 12 |
| result | diameter of | | | | | | | |
| | solid lubricant | | | | | | | |
| | Tensile | MPa | 51 | 50 | 65 | 40 | 60 | 42 |
| | strength | | | | | | | |
| | Charpy impact | kJ/m² | 10 | 10 | 15 | 7 | 8 | 15 |
| | strength | | | | | | | |
| | Friction | | 0.25 | 0.26 | 0.37 | 0.18 | 0.24 | 0.24 |
| | coefficient | | | | | | | |
| | Specific wear | ×10⁻³ mm³/ | 25 | 25 | 40 | 10 | 35 | 25 |
| | rate | (N · km) | | | | | | |
| | Durability | h | 62 | 65 | 44 | 42 | 51 | 73 |
| | Moldability | Appearance/ | Satis- | Satis- | Satis- | Satis- | Satis- | Satis- |
| | | burr | factory/ | factory/ | factory/ | factory/ | factory/ | factory/ |
| | | | none | none | none | none | none | none |
| | Dimensional | % | 0.10 | 0.10 | 0.10 | 0.10 | 0.10 | 0.15 |
| | change | | | | | | | |

TABLE 2

| | | | Ex. 7 | Ex. 8 | Ex. 9 | Ex. 10 | Ex. 11 | Ex. 12 |
|---|---|---|---|---|---|---|---|---|
| Composition | A-3 | Part by mass | 100 | 100 | 100 | 100 | 100 | |
| | A-4 | Part by mass | | | | | | 100 |
| | B-1 | Part by mass | 20 | 20 | 10 | 15 | 15 | 5 |
| | C-1 | Part by mass | | | | 20 | 20 | 20 |
| | C-2 | Part by mass | 15 | 5 | 20 | | | |
| | D-1 | Part by mass | | | | 2 | | |
| | D-2 | Part by mass | | | | | 2 | |
| | E-1 | Part by mass | 0.5 | 0.5 | 0.5 | 0.5 | 0.5 | 0.5 |
| Evaluation | Dispersion | μm | 2 | 2 | 2 | 12 | 12 | 12 |
| result | diameter of | | | | | | | |
| | solid lubricant | | | | | | | |
| | Tensile | MPa | 55 | 60 | 45 | 47 | 46 | 60 |
| | strength | | | | | | | |
| | Charpy impact | kJ/m² | 14 | 15 | 16 | 8 | 8 | 12 |
| | strength | | | | | | | |
| | Friction | | 0.24 | 0.35 | 0.17 | 0.18 | 0.14 | 0.25 |
| | coefficient | | | | | | | |
| | Specific | ×10⁻³ mm³/ | 20 | 35 | 5 | 3 | 5 | 25 |
| | wear rate | (N · km) | | | | | | |
| | Durability | h | 75 | 50 | 67 | 71 | 90 | 80 |
| | Moldability | Appearance/ | Satis- | Satis- | Satis- | Satis- | Satis- | Satis- |
| | | burr | factory/ | factory/ | factory/ | factory/ | factory/ | factory/ |
| | | | none | none | none | none | none | none |
| | Dimensional | % | 0.10 | 0.10 | 0.10 | 0.10 | 0.10 | 0.10 |
| | change | | | | | | | |

TABLE 3

| | | | Comp. | Comp. | Comp. | Comp. |
|---|---|---|---|---|---|---|
| | | | Ex. 1 | Ex. 2 | Ex. 3 | Ex. 4 |
| Composition | a-1 | Part by mass | 100 | | | |
| | A-3 | Part by mass | | | 100 | 100 |
| | a-5 | Part by mass | | 100 | | |
| | B-1 | Part by mass | 20 | 20 | 2 | 40 |
| | C-1 | Part by mass | 20 | 20 | 20 | 20 |
| | E-1 | Part by mass | 0.5 | 0.5 | 0.5 | 0.5 |
| Evaluation | Dispersion | μm | 12 | Difficult | 12 | 12 |
| result | diameter of | | | to mold | | |
| | solid lubricant | | | | | |
| | Tensile | MPa | 47 | — | 58 | 35 |
| | strength | | | | | |
| | Charpy impact | kJ/m² | 10 | — | 2 | 2 |
| | strength | | | | | |
| | Friction | | 0.26 | — | 0.24 | 0.28 |
| | coefficient | | | | | |
| | Specific | ×10⁻³ mm³/ | 25 | — | 70 | 25 |
| | wear rate | (N · km) | | | | |
| | Durability | h | 24 | — | 4 | 5 |
| | Moldability | Appearance/ | Satis- | Unsatis- | Satis- | Satis- |
| | | burr | factory/ | factory | factory/ | factory/ |
| | | | presence | | none | none |
| | Dimensional | % | 0.10 | — | 0.10 | 0.30 |
| | change | | | | | |

TABLE 4

| | | | Comp. | Comp. | Comp. | Comp. | Comp. |
|---|---|---|---|---|---|---|---|
| | | | Ex. 5 | Ex. 6 | Ex. 7 | Ex. 8 | Ex. 9 |
| Composition | A-3 | Part by mass | 100 | 100 | 100 | 100 | 100 |
| | B-1 | Part by mass | 20 | 20 | 20 | 20 | |
| | b-2 | Part by mass | | | | | 20 |
| | C-1 | Part by mass | 2 | 40 | | | 20 |
| | C-2 | Part by mass | | | 2 | 35 | |
| | E-1 | Part by mass | 0.5 | 0.5 | 0.5 | 0.5 | 0.5 |
| Evaluation | Dispersion | μm | 12 | 12 | 2 | 2 | 12 |
| result | diameter of | | | | | | |
| | solid lubricant | | | | | | |
| | Tensile | MPa | 73 | 34 | 75 | 31 | 55 |
| | strength | | | | | | |
| | Charpy impact | kJ/m² | 16 | 5 | 17 | 14 | 10 |
| | strength | | | | | | |
| | Friction | | 0.45 | 0.24 | 0.42 | 0.22 | 0.33 |
| | coefficient | | | | | | |
| | Specific | ×10⁻³ mm³/ | 75 | 25 | 55 | 25 | 200 |
| | wear rate | (N · km) | | | | | |
| | Durability | h | 10 | 3 | 12 | 3 | 18 |
| | Moldability | Appearance/ | Satis- | Satis- | Satis- | Satis- | Satis- |
| | | burr | factory/ | factory/ | factory/ | factory/ | factory/ |
| | | | none | none | none | presence | none |
| | Dimensional | % | 0.10 | 0.10 | 0.10 | 0.10 | 0.10 |
| | change | | | | | | |

As the mixing ratios of the mixing components in Tables 1 to 4, the followings were used.
PPS resin
a-1: PPS resin (melt viscosity (V6): 20 Pa·s, carboxy group content: 30 μmol/g)
A-2: PPS resin (melt viscosity (V6): 50 Pa·s, carboxy group content: 30 μmol/g)
A-3: PPS resin (melt viscosity (V6): 120 Pa·s, carboxy group content: 30 μmol/g)
A-4: PPS resin (melt viscosity (V6): 2,000 Pa·s, carboxy group content: 20 μmol/g)
a-5: PPS resin (melt viscosity (V6): 4,000 Pa·s, carboxy group content: 20 μmol/g)
Fiber filler
B-1: polyamide fibers (para-type aramid fibers, average fiber length: 3 mm)
b-2: glass fibers “T-717H” manufactured by Nippon Electric Glass Co., Ltd., average fiber length: 3.5 mm
Solid lubricant
C-1: PTFE “KT-600M” (dynamic friction coefficient: 0.04) manufactured by Kitamura Limited
C-2: polyethylene “LUBMER LY1040” (dynamic friction coefficient: 0.15) manufactured by Mitsui Chemicals, Inc.
Liquid silicone resin D-1: “KF-96-1000CS” (kinematic viscosity: 1,000 mm²/s) manufactured by Shin-Etsu Chemical Co., Ltd.
D-2: “KF-10000CS” (kinematic viscosity: 10,000 mm²/s) manufactured by Shin-Etsu Chemical Co., Ltd.
Silane coupling material
E-1: “XIAMETER (registered trademark) OFS-6040” manufactured by Dow Chemical Company

Tables 1 to 4 showed that in comparison between Examples and Comparative Examples 1 and 2, when the melt viscosity of the resin is outside a specific range, the moldability and the durability of the gear are poor. In comparison between Examples and Comparative Examples 3 and 4, it was shown that when the mixing amount of the PA fibers is outside a specific range, the mechanical properties, the sliding properties, and the dimensional change ratio are deteriorated. In comparison between Examples and Comparative Examples 5 to 8, it was shown that when the mixing amount of the solid lubricant is outside a specific range, the mechanical properties and the sliding properties are poor. In comparison between Examples and Comparative Example 9, it was shown that when the fiber filler including another resin other than the PA resin was used, the specific wear rate is large.

1. A poly(arylene sulfide) resin composition obtained by mixing a poly(arylene sulfide) resin (A), polyamide fibers (B), and a solid lubricant (C), wherein
the poly(arylene sulfide) resin (A) has a melt viscosity (V6) of 50 to 2,000 Pa s, measured after being held at 300° C., a load of 1.96×10⁶ Pa, and L/D of 10 (mm)/1 (mm) for 6 minutes,
the polyamide fibers (B) are mixed in an amount of 5 to 35 parts by mass and the solid lubricant (C) is mixed in an amount of 5 to 30 parts by mass, relative to 100 parts by mass of the poly(arylene sulfide) resin (A), and
a molded article in which a molten resin is filled symmetrically from both ends of a dumbbell shape conforming to a specimen of type A defined in ISO 20753 has a tensile strength of a weld part of 40 MPa or more in ISO 527-1 and 2.

2. The poly(arylene sulfide) resin composition according to claim 1, wherein the poly(arylene sulfide) resin (A) has a carboxy group in the molecular structure, and a content of the functional group is 10 to 200 mol/g.

3. The poly(arylene sulfide) resin composition according to claim 1, wherein the solid lubricant (C) has a dispersion diameter of 50 m or less.

4. The poly(arylene sulfide) resin composition according to claim 1, wherein the solid lubricant (C) contains polytetrafluoroethylene or polyethylene.

5. The poly(arylene sulfide) resin composition according to claim 1, wherein a liquid silicone resin (D) is further mixed in an amount of 1 to 5 parts by mass relative to 100 parts by mass of the poly(arylene sulfide) resin (A).

6. The poly(arylene sulfide) resin composition according to claim 5, wherein the liquid silicone resin (D) has a kinematic viscosity of 100 to 30,000 mm²/s.

7. A molded article obtained by melt-molding the poly(arylene sulfide) resin composition according to claim 1.

8. A sliding member obtained by melt-molding the poly(arylene sulfide) resin composition according to claim 1.

9. A gear obtained by melt-molding the poly(arylene sulfide) resin composition according to claim 1.

10. A production method for a poly(arylene sulfide) resin composition, the method comprising a step of mixing a poly(arylene sulfide) resin (A), polyamide fibers (B), and a solid lubricant (C), and melt-kneading the mixture at a temperature equal to or higher than the melting point of the poly(arylene sulfide) resin (A), wherein
the poly(arylene sulfide) resin (A) has a melt viscosity (V6) of 50 to 2,000 Pa s, measured after being held at 300° C., a load of 1.96×10⁶ Pa, and L/D of 10 (mm)/1 (mm) for 6 minutes,
the polyamide fibers (B) are mixed in an amount of 5 to 35 parts by mass and the solid lubricant (C) is mixed in an amount of 5 to 30 parts by mass, relative to 100 parts by mass of the poly(arylene sulfide) resin (A), and
a molded article in which a molten resin is filled symmetrically from both ends of a dumbbell shape conforming to a specimen of type A defined in ISO 20753 has a tensile strength of a weld part of 40 MPa or more in ISO 527-1 and 2.

11. The production method for a poly(arylene sulfide) resin composition according to claim 10, wherein the poly(arylene sulfide) resin (A) has a carboxy group in the molecular structure, and a content of the functional group is 10 to 200 μmol/g.

12. The production method for a poly(arylene sulfide) resin composition according to claim 10, wherein the solid lubricant (C) has a dispersion diameter of 50 μm or less.

13. The production method for a poly(arylene sulfide) resin composition according to claim 10, wherein the solid lubricant (C) contains polytetrafluoroethylene or polyethylene.

14. The production method for a poly(arylene sulfide) resin composition according to claim 10, wherein a liquid silicone resin (D) is further mixed in an amount of 1 to 10 parts by mass relative to 100 parts by mass of the poly(arylene sulfide) resin (A).

15. The production method for a poly(arylene sulfide) resin composition according to claim 14, wherein the liquid silicone resin (B) has a kinematic viscosity of 100 to 30,000 mm²/s.

16. A production method for a molded article comprising a step of melt-molding a poly(arylene sulfide) resin composition obtained by the production method for a poly(arylene sulfide) resin composition according to claim 10.

17. The poly(arylene sulfide) resin composition according to claim 2, wherein the solid lubricant (C) has a dispersion diameter of 50 m or less.

18. The poly(arylene sulfide) resin composition according to claim 2, wherein the solid lubricant (C) contains polytetrafluoroethylene or polyethylene.

19. The poly(arylene sulfide) resin composition according to claim 2, wherein a liquid silicone resin (D) is further mixed in an amount of 1 to 5 parts by mass relative to 100 parts by mass of the poly(arylene sulfide) resin (A).

20. The poly(arylene sulfide) resin composition according to claim 19, wherein the liquid silicone resin (D) has a kinematic viscosity of 100 to 30,000 mm²/s.
